(19) United States
(12) Patent Application Publication
(10) Pub. No.: US 2018/0272723 A1
(43) Pub. Date: Sep. 27, 2018

(54) INK REPLENISHMENT ASSIST APPARATUS AND INK REPLENISHMENT APPARATUS

(71) Applicant: SEIKO EPSON CORPORATION, Tokyo (JP)

(72) Inventors: Satoshi SHINADA, Shiojiri-shi (JP); Tadahiro MIZUTANI, Shiojiri-shi (JP); Taku ISHIZAWA, Matsumoto-shi (JP); Noriyuki FUKASAWA, Shiojiri-shi (JP); Tadashi WATANABE, Matsumoto-shi (JP)

(73) Assignee: SEIKO EPSON CORPORATION, Tokyo (JP)

(21) Appl. No.: 15/923,431

(22) Filed: Mar. 16, 2018

(30) Foreign Application Priority Data
Mar. 27, 2017 (JP) 2017-060537

(51) Int. Cl. B41J 2/175; B67D 7/02

(52) U.S. Cl. CPC B41J 2/17509; B67D 7/0288

(57) ABSTRACT

At least one of making an ink replenishing operation easy and making it possible to select one out of a plurality of types of ink replenishment containers in order to perform ink replenishment is achieved. An ink replenishment assist apparatus includes a plug detachably mounted to the ink inlet of an ink tank and a conduit. The conduit has a first opening open to the inside of the ink tank in an in-use state of the ink replenishment assist apparatus, a second opening positioned on an opposite side to the first opening, and open to the outside of the ink tank, and a channel that brings the first opening and the second opening into communication with each other.

### CROSS REFERENCE TO RELATED APPLICATIONS

The present application claims priority from Japanese Patent Application No. 2017-060537 filed on Mar. 27, 2017, the contents of which are hereby incorporated by reference into this application.

### BACKGROUND

### 1. Technical Field

The present invention relates to an ink replenishment assist apparatus that is used for replenishing ink to an ink tank of a printer, and an ink replenishment apparatus that has the ink replenishment assist apparatus.

### 2. Related Art

Inkjet printers have an ink tank that stores ink, and ink is supplied from the ink tank to a printing head. There are two types of ink tanks of a printer, namely a cartridge type and an ink replenishment type. A cartridge-type ink tank is replaced with a new ink tank when the residual ink amount becomes low. An ink-replenishment-type ink tank is used without being replaced when the residual ink amount becomes low, and the ink tank is replenished with ink from an ink replenishment container (e.g., an ink bottle).

JP-A-2016-087844 discloses an ink bottle that is used for replenishing an ink-replenishment-type ink tank with ink. In this conventional technique, a positioning projection is provided in the vicinity of an ink outlet port of the ink bottle, and ink replenishment is performed by squeezing the bottle body of the ink bottle in a state where the projection abuts against the end portion of an ink inlet of the ink tank.

According to the above-described conventional technique, it is necessary to squeeze the bottle body in a state where the ink bottle is held in a hand so as to perform a replenishing operation, and there is a problem that an ink replenishing operation is not easy.

### SUMMARY

An advantage of some aspects of the invention is to provide an ink replenishment assist apparatus that makes an ink replenishing operation easy. Another advantage of the invention is to provide an ink replenishment assist apparatus that makes it possible to replenish an ink tank with ink from a plurality of types of ink replenishment containers.

The invention has been made in order to solve at least a portion of the above-described issue, and can be realized as the following aspects or application examples.

(1) According to one aspect of the invention, an ink replenishment assist apparatus for replenishing an ink tank provided with an ink inlet with ink is provided. This ink replenishment assist apparatus includes a plug that can be detachably attached to the ink inlet; and a cylindrical conduit that is provided so as to be coupled with the plug, and brings inside and outside of the ink tank into communication with each other in an in-use state where the plug is mounted on the ink inlet. The conduit has a first opening that is open to the inside of the ink tank in the in-use state, a second opening that is positioned on an opposite side to the first opening, and is open to the outside of the ink tank in the in-use state, and a channel that brings the first opening and the second opening into communication with each other.

With this ink replenishment assist apparatus, when the ink replenishment assist apparatus is mounted to the inlet of the ink tank, and an ink replenishment container is connected on the second opening side of the cylindrical conduit, ink flows through the conduit into the ink tank, and air in the ink tank flows out through the conduit, and thus the ink tank can be replenished with ink easily without squeezing the ink replenishment container. In addition, air-liquid exchange is performed via the conduit, and thus ink replenishment can be performed relatively quickly. Preferably, the conduit may include a plurality of channels so that the ink flows from at least one of the plurality of channels into the ink tank and the air in the ink tank flows out from the other channel.

(2) In the above-described ink replenishment assist apparatus, the second opening may be formed such that an area of an opening face of the second opening is smaller than an area of an opening face of the ink inlet.

According to this configuration, the opening area of the second opening is smaller than the opening area of the ink inlet, and thus dust and the like are unlikely to enter the ink tank. Furthermore, since the opening area of the second opening is smaller than the opening area of the ink inlet, and the conduit is tubular, it is possible to connect, to the conduit, various ink replenishment containers having an ink outlet into which the conduit on the second opening side can be inserted, so as to perform ink replenishment, and it is possible to select one out of various types of ink replenishment containers, and to replenish the ink tank with ink.

(3) In the above-described ink replenishment assist apparatus, the conduit may be formed such that, in the in-use state, the first opening is positioned inward of an ink inlet member that forms the ink inlet, in the ink tank.

According to this configuration, the first opening is closer to the liquid surface of ink than the ink inlet member, and thus it is possible to reduce foaming during ink replenishment.

(4) In the above-described ink replenishment assist apparatus, the conduit may be formed such that, in the in-use state, the first opening is positioned in a larger space in the ink tank than the ink inlet.

According to this configuration, ink splash that occurs during ink replenishment is contained in the space in the ink tank, and thus a possibility that ink scatters from the ink inlet to the outside reduces.

(5) In the above-described ink replenishment assist apparatus, the conduit may be formed such that, in the in-use state, the first opening is positioned at a height of a liquid surface when the ink tank is fully filled with ink.

According to this configuration, when the liquid surface of ink in the ink tank reaches the liquid surface when the ink tank is fully filled with ink, air-liquid exchange stops, and thus ink replenishment is stopped automatically. In addition, the user can recognize that the ink tank is fully filled with ink.

(6) In the above-described ink replenishment assist apparatus, the conduit includes a plurality of channels, and the first openings of the plurality of channels are arranged at different positions in a direction along the channels.

According to this configuration, a position at which ink flows from the ink replenishment container into the ink tank and a position at which air flows out from the ink tank to the ink replenishment container are different positions, and thus air-liquid exchange is smoothly performed, and ink replenishment is performed quickly.

(7) In the above-described ink replenishment assist apparatus, the plug may include an ink receiver formed in a periphery of the conduit, on the second opening side of the plug.

According to this configuration, it is possible to collect, in the ink receiver, ink that leaked when ink replenishment is performed via the second opening, and contamination of a surrounding region with ink can be suppressed.

(8) In the above-described ink replenishment assist apparatus, a cap that covers the second opening of the conduit may be further included.

According to this configuration, evaporation of ink from the second opening can be reduced by covering the second opening with the cap when ink replenishment is not performed. It is also possible to suppress ink leakage from the second opening when the orientation of the ink tank is changed.

(9) In the above-described ink replenishment assist apparatus, the plug may be configured to be attached to the ink inlet by pushing-in.

According to this configuration, the plug can be easily attached to the ink inlet.

(10) In the above-described ink replenishment assist apparatus, the plug may be formed of a member having rubber elasticity.

According to this configuration, a configuration is possible in which mounting/removal of the plug to/from the ink inlet is easy.

(11) In the above-described ink replenishment assist apparatus, the plug may include a positioning face that abuts against a leading end of the ink inlet in the in-use state so as to position the plug.

According to this configuration, it is possible to position the plug, and prevent rise of the plug when mounting the plug to ink inlet. Therefore, possibility of ink leakage from the ink inlet can be reduced.

(12) Another aspect of the invention is an ink replenishment apparatus that has one of the above-described ink replenishment assist apparatuses, and an ink replenishment container for replenishing the ink tank with ink from the second opening using the ink replenishment assist apparatus.

With this ink replenishment apparatus, an ink replenishing operation can be performed easily.

(13) In the above-described ink replenishment apparatus, the ink replenishment container may include an ink outlet, and a sealing portion that can open/close the ink outlet, and be configured such that the conduit on the second opening side is inserted into the sealing portion when the ink replenishment container is connected to the ink replenishment assist apparatus, and the ink replenishment assist apparatus may be configured such that a force required to remove the plug of the ink replenishment assist apparatus from the ink inlet is larger than a force required to remove the sealing portion of the ink replenishment container from the conduit of the ink replenishment assist apparatus.

According to this configuration, when removing the ink replenishment container from the ink replenishment assist apparatus, the ink replenishment assist apparatus is unlikely detached from the ink inlet of the ink tank. Therefore, a possibility that ink scatters due to detachment of the ink replenishment assist apparatus is reduced.

(14) In the above-described ink replenishment apparatus, the plug may include a positioning portion for positioning a connection position between the ink outlet of the ink replenishment container and the conduit when the ink replenishment container is connected to the ink replenishment apparatus.

According to this configuration, it is possible to position the ink replenishment container relative to the ink replenishment assist apparatus, and perform ink replenishment with an appropriate positional relationship.

The invention can be realized in various aspects other than the above-described ink replenishment assist apparatus and ink replenishment apparatus. For example, the invention can be realized in an aspect of an ink replenishment system having an ink tank and an ink replenishment apparatus, or the like.

### BRIEF DESCRIPTION OF THE DRAWINGS

The invention will be described with reference to the accompanying drawings, wherein like numbers reference like elements.

FIG. 1 is a perspective view of a printing system of an embodiment of the invention.

FIG. 2 is a perspective view of an ink tank unit.

FIG. 3 is a perspective view showing an ink tank, an ink replenishment assist apparatus, and an ink replenishment container.

FIG. 4 is a perspective view of an ink replenishment assist apparatus of a first embodiment.

FIG. 5 is a longitudinal cross-sectional view of the ink replenishment assist apparatus of the first embodiment.

FIG. 6 is a cross-sectional view showing a state where an ink replenishment assist apparatus and an ink replenishment container are used.

FIG. 7 is an enlarged view of a portion of FIG. 6.

FIG. 8 is a cross-sectional view showing an ink replenishment assist apparatus of a second embodiment.

FIG. 9 is a cross-sectional view showing a state where an ink replenishment assist apparatus of the third embodiment and an ink replenishment container are used.

### DESCRIPTION OF EXEMPLARY EMBODIMENTS

### First Embodiment

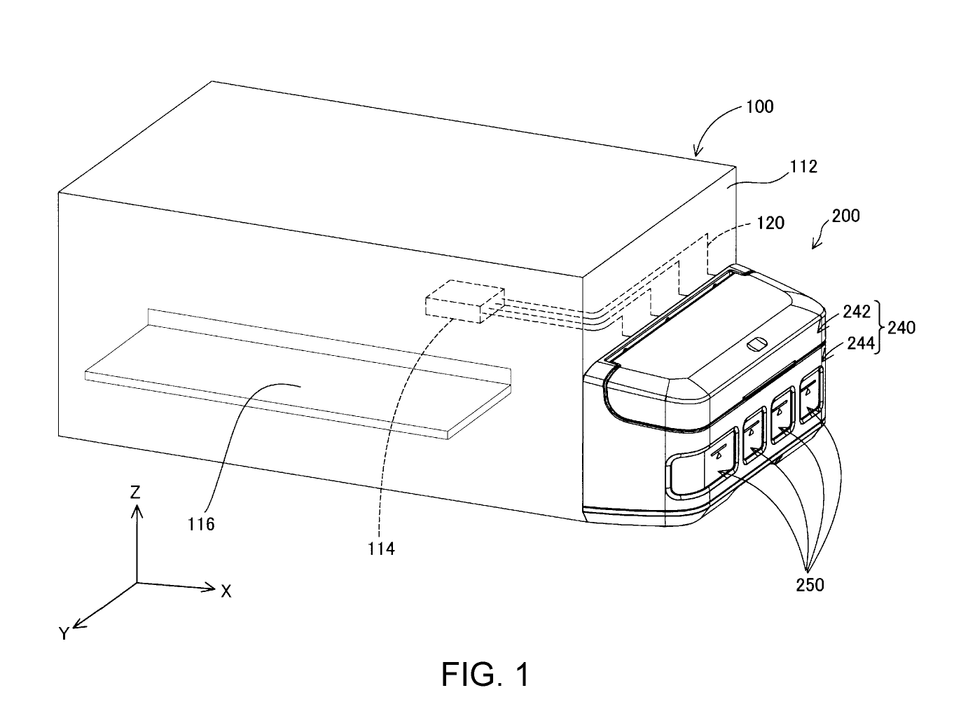

FIG. 1 is a perspective view of a printing system as an embodiment of the invention. In FIG. 1, X, Y, and Z axes orthogonal to each other are illustrated. Note that, also in other drawings, X, Y, and Z axes corresponding to those in FIG. 1 are illustrated as necessary. This printing system has a printer 100 and an ink tank unit 200. The printer 100 is an inkjet printer that performs printing by discharging ink onto a printing medium. The printer 100 and the ink tank unit 200 are installed on a horizontal surface defined by an X axis direction and a Y axis direction. Accordingly, a Z axis direction is the vertical direction (the up-down direction). Also, a −Z axis direction is the vertical downward direction, and a +Z axis direction is the vertical upward direction.

The printer 100 has a case 112 and a printing head 114 accommodated in the case 112. A discharge tray 116 from which a printing medium is discharged is provided in the front face of the case 112. The printing head 114 is configured to be movable in a main scanning direction (the X axis direction).

The ink tank unit 200 is mounted at an external wall surface of the case 112. The ink tank unit 200 has a case 240 and a plurality of the ink tanks 250 arranged in the case 240. The ink tanks 250 are accommodated in the case 240 in a state where the amount of ink (the liquid surface of ink) can be visually recognized from outside. The case 240 has a case body 244 that houses the ink tanks 250, and a cover 242 that is mounted to the case body 244 so as to be able to open/close the case body 244. The ink tanks 250 are in communication with the printing head 114 via respective ink supply tubes 120. Ink contained in the ink tanks 250 is supplied to the printing head 114 through the ink supply tubes 120. These ink tanks 250 are stationary ink tanks that are not placed on a carriage (not illustrated) equipped with the printing head 114.

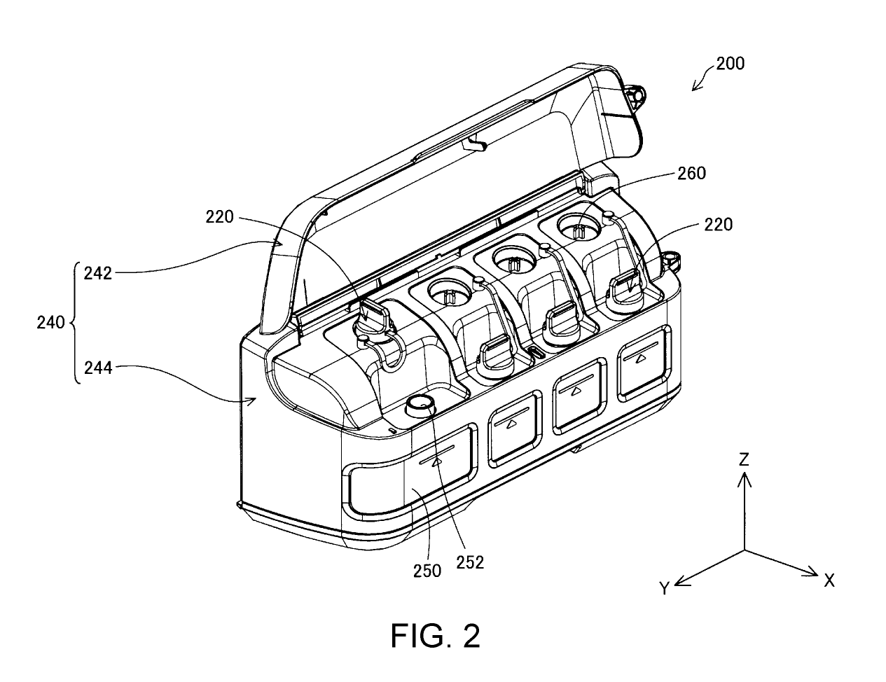

FIG. 2 is a perspective view of the ink tank unit 200. Usually, ink inlets 252 of the ink tanks 250 are respectively covered by plug members 220. Regarding the leftmost ink tank 250 in FIG. 2, the plug member 220 is removed from the ink inlet 252, and is arranged on a plug member arrangement portion 260. The ink inlet 252 is open at an upper portion of the ink tank 250. When the ink tank 250 is replenished with ink, the user removes the plug member 220 from the ink inlet 252 after opening the cover 242, as shown in FIG. 2. The ink tank 250 is then replenished with ink from the ink inlet 252.

In the present specification, the term “ink replenishment” refers to an operation of increasing the residual ink amount by supplying ink to the ink tank 250. Note that the ink tank 250 does not need to be fully filled with ink by performing “ink replenishment”. Also, “Ink replenishment” includes an operation of filing an empty ink tank 250 with ink when using the printer 100 for the first time.

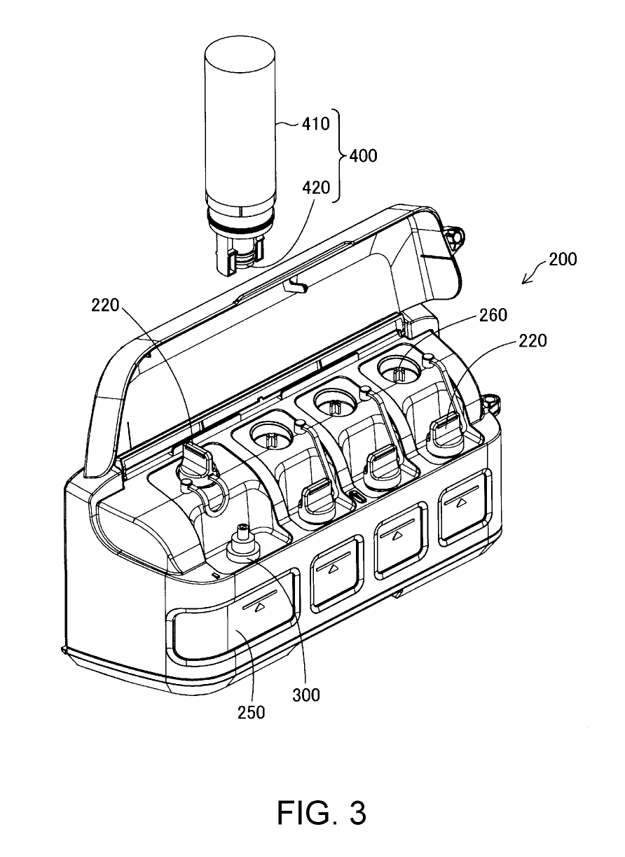

FIG. 3 is a perspective view showing the ink tanks 250, an ink replenishment assist apparatus 300 as an attachment, and an ink replenishment container 400. In the state in FIG. 3, the ink replenishment assist apparatus 300 is mounted on the ink inlet 252 of the leftmost ink tank 250. The configuration of the ink replenishment assist apparatus 300 will be described later. The ink replenishment container 400 has a container body 410 that stores ink, and an ink outlet 420 that is mounted on the container body 410. The ink outlet 420 can be detachably mounted to the ink replenishment assist apparatus 300. The ink replenishment assist apparatus 300 and the ink replenishment container 400 constitute an ink replenishment apparatus as a whole.

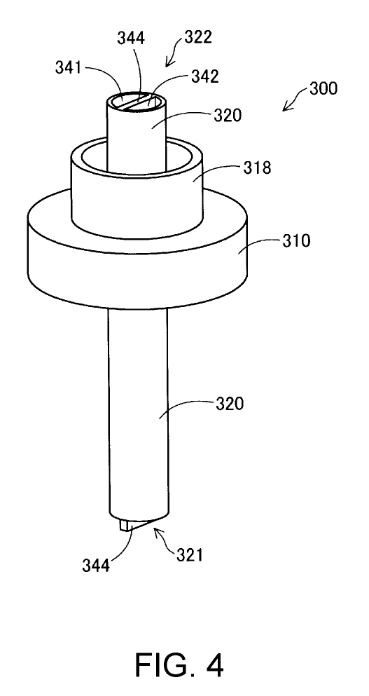

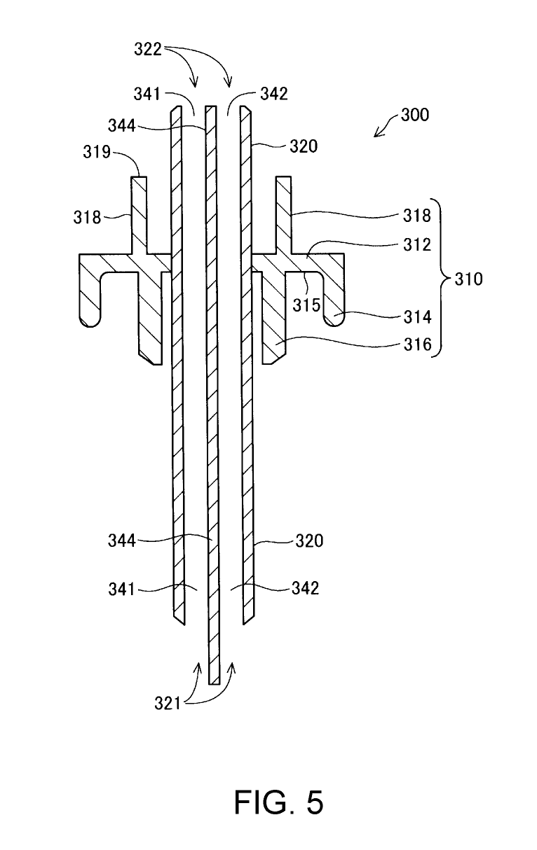

FIG. 4 is a perspective view of the ink replenishment assist apparatus 300 of the first embodiment, and FIG. 5 is a longitudinal cross-sectional view of the ink replenishment assist apparatus 300 in FIG. 4. The ink replenishment assist apparatus 300 has a plug 310 and a cylindrical conduit 320 provided so as to be coupled with the plug 310. The ink replenishment assist apparatus 300 can be formed of a thermoplastic resin such as polyethylene or polypropylene, or a member having rubber elasticity (silicone rubber or an elastomer), for example. Note that it is preferred that the entirely of the ink replenishment assist apparatus 300 is integrally molded of a resin. This makes it easy to perform an operation of mounting the ink replenishment assist apparatus 300 to the ink inlet 252 of the ink tank 250. In the cross-sectional view in FIG. 5, different hatchings are applied to the plug 310 and the conduit 320 in order to clearly distinguish between the plug 310 and the conduit 320, and the plug 310 and the conduit 320 may be formed of the same material. Note that the plug 310 and the conduit 320 can also be formed of different materials. Specifically, for example, a configuration is adopted in which the plug 310 is formed of a member with rubber elasticity, and the conduit 320 is formed of a thermoplastic resin without rubber elasticity. Also in a case where the plug 310 and the conduit 320 are formed of different materials, it is preferred that the plug 310 and the conduit 320 are integrally molded.

The plug 310 is a portion that can be detachably mounted to the ink inlet 252 of the ink tank 250 (FIG. 3). In the example shown in FIG. 5, the plug 310 has an annular plate-like portion 312 that surrounds the conduit 320, and a first wall portion 314 and a second wall portion 316 that extend downward from the plate-like portion 312. The first wall portion 314 is a cylindrical portion that extends downward from the vicinity of the edge portion on the outer periphery side of the plate-like portion 312. The second wall portion 316 is a cylindrical portion that extends downward from the lower surface of the plate-like portion 312, on the inner periphery side relative to the first wall portion 314. A positioning face 315 is formed between these two wall portions 314 and 316. The positioning face 315 has a function for abutting against the leading end of the ink inlet 252 of the ink tank 250 so as to position the plug 310, in an in-use state of the ink replenishment assist apparatus 300. In the present specification, the “in-use state of the ink replenishment assist apparatus 300” refers to a state where the plug 310 is mounted on the ink inlet 252 of the ink tank 250.

The conduit 320 is a portion that brings the inside and the outside of the ink tank 250 into communication with each other in the in-use state of the ink replenishment assist apparatus 300. The conduit 320 has a first opening 321 on the lower end side and a second opening 322 on the opposite side to the first opening 321. In the conduit 320, a plurality of channels 341 and 342 are formed along the axial direction of the conduit 320. The plurality of channels 341 and 342 are partitioned by a partition wall 344. When ink is replenished, one of the two channels 341 and 342 is used as a channel for ink, and the other is used for a channel for air. As a result, the ink replenishment container 400 can replenish the ink tank 250 with ink while performing air-liquid exchange. When replenishing the ink tank 250 with ink using air-liquid exchange, the container body 410 (FIG. 3) does not need to be squeezed. The type of an ink replenishment container that makes it possible to replenish the ink tank 250 with ink without squeezing the container body 410 in this manner is called a “non-compression type”. The conduit 320 includes the plurality of channels 341 and 342, and thus the ink replenishment assist apparatus 300 of the first embodiment can perform ink replenishment relatively quickly using the ink replenishment container 400 of a non-compression type. Note that the number of channels in the conduit 320 is not limited to two, and may be set to three or more.

The plug 310 further has an ink receiver 318 formed in the periphery of the conduit 320, on the second opening 322 side of the plug 310. The ink receiver 318 forms a space in which ink can be contained, between the conduit 320 and the ink receiver 318. A function of the ink receiver 318 will be described later.

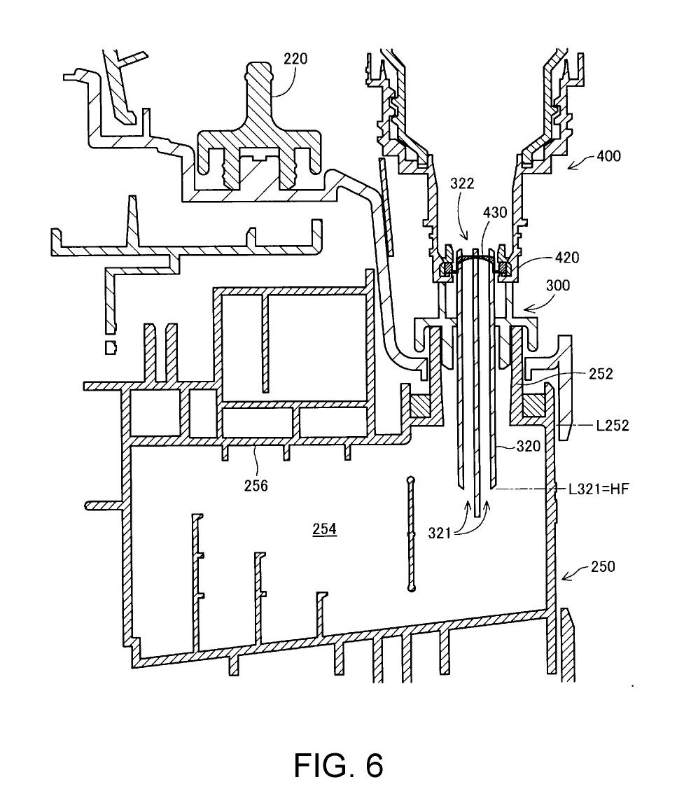

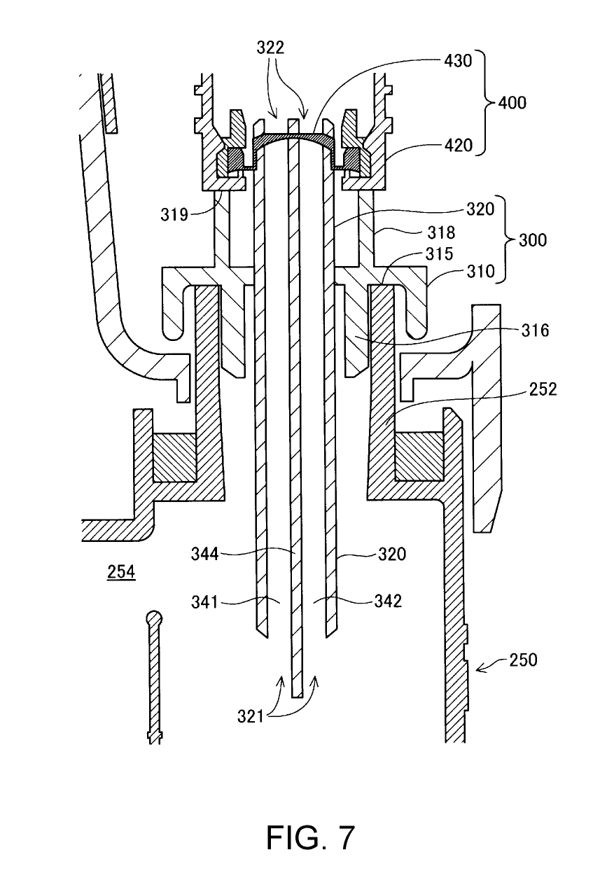

FIG. 6 is a cross-sectional view showing a state where the ink replenishment assist apparatus 300 and the ink replenishment container 400 are used, and FIG. 7 is an enlarged view of a portion of FIG. 6. This state is an ink replenishment state where the ink replenishment assist apparatus 300 is used for replenishing the ink tank 250 with ink. In this ink replenishment state, the ink replenishment assist apparatus 300 is in an in-use state. As described above, the “in-use state of the ink replenishment assist apparatus 300” means a state where the plug 310 of the ink replenishment assist apparatus 300 is mounted on the ink inlet 252 of the ink tank 250. Note that even if the ink replenishment container 400 is not mounted on the ink replenishment assist apparatus 300, a state where the plug 310 of the ink replenishment assist apparatus 300 is mounted on the ink inlet 252 of the ink tank 250 is equivalent to the “in-use state of the ink replenishment assist apparatus 300”.

In the in-use state in FIG. 6, the first opening 321 of the conduit 320 is open toward the inside of the ink tank 250, and the second opening 322 is open toward the outside of the ink tank 250. Note that it is preferred that the second opening 322 is formed such that the area of the opening face of the second openings 322 at the upper end of the conduit 320 in the in-use condition is smaller than the area of the opening face at the upper end of the ink inlet 252 of the ink tank 250. This provides an advantage that, even in a state where the ink replenishment container 400 is not mounted on the ink replenishment assist apparatus 300, dust and the like are unlikely to enter the ink tank. The conduit 320 is formed so as to have the second opening 322 smaller than the opening area of the ink inlet 252 of the ink tank 250, and to have a cylindrical shape. Therefore, the ink tank 250 can be replenished with ink using various ink replenishment containers having the ink outlet 420 into which the conduit 320 on the second opening 322 side can be inserted, and it is possible to select one out of various types of ink replenishment containers, and replenish the ink tank 250 with ink from the selected ink replenishment container. Note that the area of the opening face of the second opening 322 is an area that is calculated in a state where the second opening 322 is projected on a projection plane that is perpendicular to a direction in which the conduit 320 extends. The area of the opening face of the ink inlet 252 of the ink tank 250 is calculated in a state where the ink inlet 252 is projected on the same projection plane.

The first opening 321 of the conduit 320 is formed so as to be positioned inward of an ink inlet member that forms the ink inlet 252 of the ink tank 250, in the ink tank 250, in the in-use state. FIG. 6 shows a lower end position L321 of the first opening 321 and a lower end position L252 of the ink inlet member that forms the ink inlet 252. The lower end position L321 of the first opening 321 is set to be positioned inward of the lower end position L252 of the ink inlet member that forms the ink inlet 252, in the ink tank 250. If the first opening 321 of the conduit 320 is formed so as to be positioned, in the ink tank 250, inward of the ink inlet member that forms the ink inlet 252 of the ink tank 250 in this manner, the first opening 321 is closer to the liquid surface of ink than the ink inlet 252, and thus it is possible to reduce foaming during ink replenishment.

Also, the conduit 320 is configured such that, in the in-use state, the first opening 321 is positioned in an ink chamber 254 of the ink tank 250. This ink chamber 254 has a space larger than the ink inlet 252. The “space larger than the ink inlet 252” refers to a space having a cross-sectional area larger than the cross-sectional area of the lower end portion of the ink inlet forming member that forms the ink inlet 252. In such a configuration in which the first opening 321 of the conduit 320 is positioned in a space larger than the ink inlet 252, in the ink tank 250, ink splash that occurs during ink replenishment is contained in the space in the ink tank, and thus there is an advantage that a possibility of ink scattering from the ink inlet 252 to the outside reduces.

The conduit 320 is further formed such that, in the in-use state, the first opening 321 is positioned at a height of a liquid surface HF when the ink tank 250 is fully filled with ink. Specifically, as shown in FIG. 6, the lower end position L321 of the first opening 321 is at a height that is equal to the liquid surface HF when the ink tank 250 is fully filled with ink. During ink replenishment, when the liquid surface of ink in the ink tank 250 reaches the liquid surface HF when the ink tank 250 is fully filled with ink, the air in the ink tank 250 cannot move to the ink replenishment container 400 side. As a result, air-liquid exchange between the ink tank 250 and the ink replenishment container 400 stops, and thus ink replenishment is stopped automatically. When ink replenishment automatically stops, the user can recognize that the ink tank 250 is fully filled with ink. Note that the liquid surface HF when the ink tank 250 is fully filled with ink is preferably set at a position lower than a ceiling face 256 of the ink chamber 254.

As enlarged and shown in FIG. 7, the ink receiver 318 of the plug 310 is formed in the periphery of the conduit 320, on the second opening 322 side of the plug 310. The ink receiver 318 forms a space in which ink can be contained, between the conduit 320 and the ink receiver 318. This ink receiver 318 has a function as a receiving plate that receives ink that has leaked from the ink replenishment container 400. If the ink receiver 318 as described above is provided, when the ink tank 250 is replenished with ink via the second opening 322, ink that leaked can be collected in the ink receiver 318, and thus there is an advantage that contamination in the surrounding region due to ink can be suppressed. Note that the ink receiver 318 may be omitted.

Note that it is preferred that the ink replenishment assist apparatus 300 is configured to be able to be mounted/removed to/from the ink inlet 252 of the ink tank 250 without using a fixing member as another member such as a screw or a bolt. For this reason, it is preferred that the plug 310 is configured to be mounted to the ink inlet 252 by pressing-in, for example. This makes it easy to mount/remove the ink replenishment assist apparatus 300 to/from the ink tank 250. In particular, it is preferred that the plug 310 is formed of a member having rubber elasticity. Silicone rubber or an elastomer can be used as the member having rubber elasticity. If the plug 310 is formed of a member having rubber elasticity, there is an advantage that mounting/removing the plug 310 to/from the ink inlet 252 is easy. The contact portion between the outer peripheral surface of the second wall portion 316 of the plug 310 and the inner peripheral surface of the ink inlet 252 constitutes a sealing portion that seals ink. Note that the ink replenishment assist apparatus 300 may be configured such that the sealing portion between the plug 310 and the ink inlet 252 is formed on the outer peripheral surface side of the ink inlet 252. In addition, in order to make it easy to grip the plug 310, the plug 310 may be provided with a grip portion that utilizes friction (e.g., by having a milled surface), or a tab-like grip portion protruding outward from the plug 310.

The positioning face 315 of the plug 310 has a function for abutting against the leading end of the ink inlet 252 of the ink tank 250, and positioning the plug 310, in the in-use state. If the positioning face 315 as described above is provided, the plug 310 can be positioned, and thus rise of the plug 310 can be prevented when mounting the plug 310 to the ink inlet 252. Therefore, possibility of ink leakage from the ink inlet 252 can be reduced.

The ink replenishment container 400 has a sealing portion 430 that can open and close the ink outlet 420. The sealing portion 430 is a member configured to be closed in a state where ink replenishment is not performed, and to be open in a state where ink replenishment is performed. In addition, the sealing portion 430 has a function for sealing the outer periphery of the conduit 320 of the ink replenishment assist apparatus 300 in the in-use state of the ink replenishment assist apparatus 300. The sealing portion 430 is configured such that the conduit 320 of the ink replenishment assist apparatus 300 on the second opening 322 side is inserted into the sealing portion 430, when the ink replenishment container 400 and the ink replenishment assist apparatus 300 are connected to each other. For example, a slit valve can be used as the sealing portion 430. A slit valve is a valve in which one or more slits are provided in a member having rubber elasticity.

It is preferred that the ink replenishment assist apparatus 300 is further configured such that a force required for removing the plug 310 from the ink inlet 252 is larger than a force required for removing the sealing portion 430 of the ink replenishment container 400 from the conduit 320 of the ink replenishment assist apparatus 300. With such a configuration, there is an advantage that the ink replenishment assist apparatus 300 is not easily detached from the ink inlet 252 of the ink tank 250 when removing the ink replenishment container 400 from the ink replenishment assist apparatus 300. Therefore, it is possible to reduce possibility of ink scattering caused by detachment of the ink replenishment assist apparatus 300.

In the in-use state in FIG. 7, the leading end of the ink receiver 318 provided on the second opening 322 side of the plug 310 functions as a positioning portion 319 for positioning the connection position between the ink outlet 420 of the ink replenishment container 400 and the conduit 320 of the ink replenishment assist apparatus 300 when the ink replenishment container 400 is connected to the ink replenishment assist apparatus 300. In the example in FIG. 7, the positioning portion 319 positions the connection position between the ink outlet 420 and the conduit 320 of the ink replenishment assist apparatus 300 by abutting against the end face of the ink outlet 420. If the positioning portion 319 as described above is provided, it is possible to position the ink replenishment container 400 relative to the ink replenishment assist apparatus 300, and thus ink replenishment can be performed with appropriate positional relationship.

As described above, with the ink replenishment assist apparatus 300 of the first embodiment includes the plug 310 that can be detachably mounted to the ink inlet 252, and the cylindrical conduit 320 that brings the inside and outside of the ink tank 250 into communication with each other in the in-use state, and, in addition, the conduit 320 has the first opening 321 that is open toward the inside of the ink tank 250, the second opening 322 that is positioned on the opposite side to the first opening 321 and is open toward the outside of the ink tank 250, and the plurality of channels 341 and 342 that bring the first opening 321 and the second opening 322 into communication with each other. Therefore, if the ink replenishment container 400 is connected to the second opening 322 of the conduit 320, ink flows from at least one of the plurality of channels 341 and 342 into the ink tank 250, and air in the ink tank 250 flows out from the other channel, and thus the ink tank 250 can be replenished easily with ink without squeezing the ink replenishment container 400. In addition, the second opening 322 is formed such that the area of the opening face of the second opening 322 is smaller than the area of the opening face of the ink inlet 252. Therefore, dust and the like are unlikely to enter the ink tank, and it is possible to connect various ink replenishment container having an ink outlet into which the conduit 320 on the second opening 322 side can be inserted for ink replenishment. As a result, it is possible to select one out of various types of ink replenishment containers, in order to replenish the ink tank 250 with ink.

### Second Embodiment

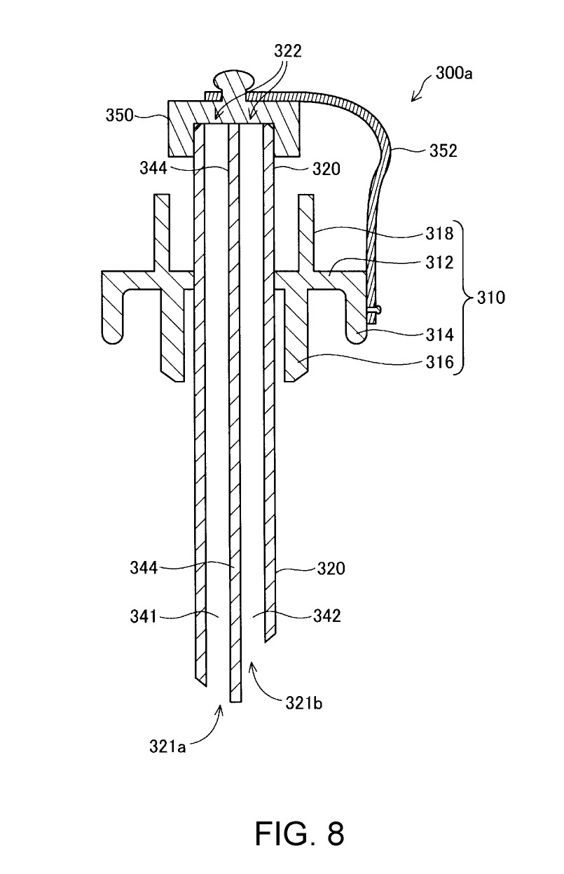

FIG. 8 is a cross-sectional view showing an ink replenishment assist apparatus 300a in a second embodiment, and corresponds to FIG. 7 described above. This ink replenishment assist apparatus 300a is different from the ink replenishment assist apparatus 300 of the first embodiment in that a cap 350 is provided, and first openings 321a and 321b at the lower end of a plurality of channels 341 and 342 are arranged at different positions in the direction along these channels 341 and 342. Note that, one of these two differences may be omitted.

The cap 350 of the ink replenishment assist apparatus 300a is a member for covering second openings 322 of a conduit 320. In the in-use state of the ink replenishment assist apparatus 300a, if the second openings 322 are covered by the cap 350 when ink replenishment is not performed, evaporation of ink from the second openings 322 can be reduced. In addition, when the orientation of an ink tank 250 is changed, ink leakage from the second openings 322 can be suppressed. In the second embodiment, the cap 350 is coupled to a plug 310 using a coupling member 352. With such a configuration, a possibility that the cap 350 is lost can be reduced.

In addition, the ink replenishment assist apparatus 300a of the second embodiment is configured such that, in the in-use state thereof, the first opening 321a of one channel, namely the channel 341 is positioned lower than the first opening 321b of the other channel, namely the channel 342. If the first openings 321a and 321b of the plurality of channels 341 and 342 are arranged at different positions in a direction along these channels 341 and 342 in this manner, a position at which ink flows from an ink replenishment container 400 into the ink tank 250 and a position at which air flows out from the ink tank 250 to the ink replenishment container 400 are different positions. As a result, air-liquid exchange is performed smoothly, and ink replenishment is performed quickly. Note that, in this configuration, the lower end position L321 of the first opening 321 described with reference to FIG. 6 is lower of the lower end positions of first openings 321a and 321b of the plurality of channels 341 and 342. This is because when air stops moving from the ink tank 250 to the ink replenishment container 400 side via the first opening 321a that is lowest, air-liquid exchange stops, and thus the position of the first opening 321a matches the liquid surface HF when the ink tank 250 is fully filled with ink.

Note that, in the example in FIG. 8, the “direction along the channels 341 and 342” is the vertical direction. Note that the “direction along the channels 341 and 342” can be set to an oblique direction inclined from the vertical direction. For example, when an ink inlet 252 of the ink tank 250 is directed in an oblique direction inclined from the vertical direction, it is preferred that the “direction along the channels 341 and 342” is also be set to the oblique direction. This applies to the first embodiment.

Similar to the first opening 321, also regarding the second openings 322, the second openings 322 of the channels 341 and 342 may be arranged at different positions in a direction along these channels 341 and 342. Alternatively, a configuration may be adopted in which the first openings 321 of the channels 341 and 342 are set at the same position, and the second openings 322 of the channels 341 and 342 are set at different positions.

### Third Embodiment

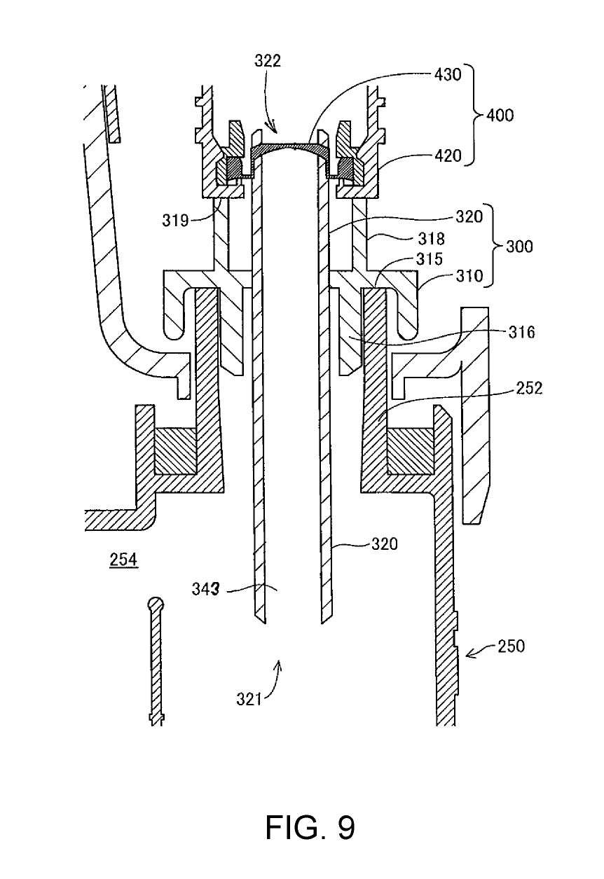

FIG. 9 is a cross-sectional view showing a state where an ink replenishment assist apparatus 300 of a third embodiment and an ink replenishment container are used.

This ink replenishment assist apparatus 300 is different from the ink replenishment assist apparatus 300 of the first embodiment in that the conduit 320 includes one channel 343. In the in-use state shown in FIG. 9, the first opening 321 of the conduit 320 is open toward the inside of the ink tank 250, and the second opening 322 is open toward the outside of the ink tank 250. Note that it is preferred that the second opening 322 is formed such that the area of the opening face of the second openings 322 at the upper end of the conduit 230 in the in-use condition is smaller than the area of the opening face at the upper end of the ink inlet 252 of the ink tank 250. The ink replenishment container 400 may be stood in the upside-down state as shown in FIGS. 6 and 9 and the ink is easily filled into the ink tank 250 through the channel 343 while the air in the ink tank 250 is exchanged through the channel 343 with the ink.

### MODIFIED EXAMPLES

The invention is not limited to the above embodiments and modified examples thereof, and can be realized in various aspects without departing from the gist of the invention.

### Modified Example 1

The invention is not limited to an ink replenishment apparatus for performing ink replenishment and an assist apparatus thereof, and can also be applied to a liquid replenishment apparatus used when performing liquid replenishment other than ink and an assist apparatus thereof.

What is claimed is:

1. An ink replenishment assist apparatus for replenishing an ink tank provided with an ink inlet with ink, comprising:
a plug configured to be detachably mounted to the ink inlet; and
a conduit configured to be coupled with the plug, and brings inside and outside of the ink tank into communication with each other in an in-use state where the plug is mounted on the ink inlet,
wherein the conduit has a first opening that is open to the inside of the ink tank in the in-use state, a second opening that is positioned on an opposite side to the first opening, and is open to the outside of the ink tank in the in-use state, and a channel that brings the first opening and the second opening into communication with each other.

2. The ink replenishment assist apparatus according to claim 1,
wherein the second opening is formed such that an area of an opening face of the second opening is smaller than an area of an opening face of the ink inlet.

3. The ink replenishment assist apparatus according to claim 1,
wherein the conduit is configured and arranged such that, in the in-use state, the first opening is positioned inward of an ink inlet member that forms the ink inlet, in the ink tank.

4. The ink replenishment assist apparatus according to claim 3,
wherein the conduit is configured and arranged such that, in the in-use state, the first opening is positioned in a larger space in the ink tank than the ink inlet.

5. The ink replenishment assist apparatus according to claim 1,
wherein the conduit is formed such that, in the in-use state, the first opening is positioned at a height of a liquid surface when the ink tank is fully filled with ink.

6. The ink replenishment assist apparatus according to claim 1
wherein the conduit includes a plurality of channels, and the first openings of the plurality of channels are arranged at different positions in a direction along the channels.

7. The ink replenishment assist apparatus according to claim 1
wherein the plug includes an ink receiver formed in a periphery of the conduit, on the second opening side of the plug.

8. The ink replenishment assist apparatus according to claim 1, further comprising:
a cap that covers the second opening of the conduit.

9. The ink replenishment assist apparatus according to claim 1,
wherein the plug is configured to be mounted to the ink inlet by pushing-in.

10. The ink replenishment assist apparatus according to claim 1
wherein the plug is formed of a member having rubber elasticity.

11. The ink replenishment assist apparatus according to claim 1,
wherein the plug includes a positioning face that abuts against a leading end of the ink inlet in the in-use state so as to position the plug.

12. An ink replenishment apparatus comprising:
the ink replenishment assist apparatus according to claim 1; and
an ink replenishment container for replenishing the ink tank with ink from the second opening using the ink replenishment assist apparatus.

13. The ink replenishment apparatus according to claim 12,
wherein the ink replenishment container includes an ink outlet, and a sealing portion that can open/close the ink outlet, and
is configured such that the conduit on the second opening side is inserted into the sealing portion when the ink replenishment container is connected to the ink replenishment assist apparatus, and
the ink replenishment assist apparatus is configured such that a force required to remove the plug of the ink replenishment assist apparatus from the ink inlet is larger than a force required to remove the sealing portion of the ink replenishment container from the conduit of the ink replenishment assist apparatus.

14. The ink replenishment apparatus according to claim 12,
wherein the plug includes a positioning portion for positioning a connection position between the ink outlet of the ink replenishment container and the conduit when the ink replenishment container is connected to the ink replenishment apparatus.
